(19) United States
(12) Patent Application Publication
(10) Pub. No.: US 2014/0252727 A1
(43) Pub. Date: Sep. 11, 2014

(54) CHUCK FOR APPARATUS FOR MACHINING A TUBULAR ROTATING WORKPIECE

(71) Applicant: SMS MEER GMBH, Möchengladbach (DE)

(72) Inventors: Karl-Josef Esser, Moenchengladbach (DE); Rainer Derix, Heinsbeg (DE)

(21) Appl. No.: 14/352,619

(22) PCT Filed: Oct. 6, 2012
(86) PCT No.: PCT/EP2012/004199

§ 371 Date: Apr. 17, 2014

(30) Foreign Application Priority Data
Nov. 8, 2011 (DE) 102011117883.3

(51) Int. Cl. B23B 31/16

(52) U.S. Cl. CPC B23B 31/16083; B23B 2231/00
USPC 279/111; 279/117

(57) ABSTRACT

The invention relates to a chuck (1) for a machine tool for machining a tubular workpiece which rotates about a rotational axis (4) that coincides with the centre of the chuck, comprising at least two chucking slides (7a, b, c) that are designed to be positionable radially with respect to the rotational axis (4) in order to release and chuck the workpiece, are arranged on the end side of and in a manner distributed uniformly around the circumference of a chuck head plate (2), and bear chucking jaws (8a, b, c). The operating characteristics for the central and/or balancing chucking of a tube are improved when each chucking slide (7a, b, c) is assigned firstly transverse slides (9a, b, c) which are provided tangentially to the rotational axis (4) in the head plate (2), are acted upon by an adjusting means and have a slide block (11) formed as a rack (12) on a longitudinal side, and secondly separate toothed wheels (19a, b, c) which mesh with the racks (12), wherein each chucking slide (7a, b, c) is provided on its underside with a driving claw (17) which, in order to deflect the movement of the transverse slide (9a, b, c) in an adjusting movement, extending at right angles to the pp rotational axis (4), of the chucking slide (7a, b, c), is in engagement with a slot-like guide groove (16) provided in the slide block (11) of the transverse slide (9a, b, c), and wherein the toothed wheels (19a, b, c) are assigned a coupling pinion (20) that can be engaged and disengaged axially with respect to the rotational axis.

The invention relates to a chuck for an apparatus for machining a tubular workpiece rotating about a rotation axis that coincides with the center of the chuck, comprising at least two chuck slides movable radially relative to the rotation axis for gripping and freeing the workpiece, mounted on a front face of a chuck head plate, equiangularly spaced on it, and carrying jaws.

An apparatus for machining pipe ends, particularly for cutting threaded connectors, of a tubular workpiece that rotates about a rotation axis, is known from DE 10 2009 053 679. The pipe thread is generally produced in a single pass over the pipe end of the chucked tubular workpiece or pipe, with the movements of the tools being controlled numerically. To clamp the pipe, a machining apparatus has a headstock chuck at the front end where an indexing head with tools is effective, and a tailstock chuck on the back end that together with the headstock chuck grips the pipe concentrically relative to the rotation axis. A machining center with at least two opposite machining apparatuses is accordingly equipped with four chucks. Both the front end chuck and the back end chuck preferably have three chuck slides with jaws, in order to release and clamp the workpiece.

In such thread-cutting machines with a rotating pipe and indexing heads carrying tools, controlled by NC shafts, machining requires at least two clamping functions. First of all, it must be possible to clamp the pipes on center in exact alignment with the machine center, and second, with adaptation to clamped pipes clamped externally in centered and eccentrically. Eccentric clamping by the chuck slides means that the chuck slides must be able to engage against the pipe, which might be slightly curved over its length, in a compensatory manner, and therefore not precisely centered. This then allows adaptation to pipes that are otherwise clamped externally on center. External centered clamping is understood to mean additional clamping of the pipe ends that project out of the front end chuck, spaced from or close to the threads to be produced later. Such chucks, particularly headstock chucks, are therefore very complex, and, in practice, tightening and loosening of the chuck slides or of the jaws carried by them takes place by wedge systems with a radial deflection relative to the center or the rotation axis of the chuck. This requires large diameters and lengths of the chucks, with a corresponding large mass, which is disadvantageous for operation.

The object of the invention is therefore to provide a chuck of the type described above but having improved operating properties.

This object is attained according to the invention, in that transverse slides transverse slides movable in the head plate tangentially relative to the rotation axis and each acted on by a respective actuator each have a slide block formed on one longitudinal side as a rack meshing with a respective gear of each chuck slide, each chuck slide being provided on a respective back face with a follower claw engaging in a respective guide groove formed in the slide block of the respective transverse slide to convert its movement into a positioning movement of the respective chuck slide that moves radially of the rotation axis, the gears having a coupling pinion that can be engaged and disengaged axially relative to the rotation axis.

Therefore a movement conversion, without wedge systems, parallel to the center of the chuck by engagement of the transverse slides that can be acted on by the actuator in the plane of the head plate, and, at the same time, radially of the rotation axis, can be achieved. This results in a lesser mass accompanied by increased dynamics and shortened run-up and braking times of the cycles that are unavoidable after each machining operation. During clamping and release of the pipe, large surface areas, namely those of the follower claw and of the guide groove in which the complementary follower claw slides, is compulsorily displaced during setting movements of the transverse slide, to transfer great forces with advantageous surface pressure. The centered and eccentric clamping does not require any increase in the construction height or length of the chuck. Centered clamping takes place by the gears connected separately with a chuck slide, in each instance, the synchronous running of which, and thereby also that of the three gears, is guaranteed by the engaged coupling pinion, while when the coupling pinion is disengaged, eccentric clamping is possible.

A preferred embodiment of the invention provides that the coupling pinion, which can be moved between an engaged and a disengaged end position, meshes with all three gears in the engaged end position, and with only one gear in the disengaged end position. Engagement and disengagement of the coupling pinion can take place manually, from the front of the chuck or of the head plate so that, when the coupling pinion is disengaged, all three slide systems and the related gears can move independently of one another, adapt to the pipe around of the center, and can clamp the pipe.

According to one suggestion of the invention, the transverse slides and the chuck slide are disposed so as to intersect at an acute angle, with an engagement angle of the travel path of the follower claw and guide groove that transfers the setting stroke of the transverse slide to the setting stroke of the chuck slide, with a gear reduction. If this angle amounts to 30°, a gear reduction of 1 to 2 (sin 0°=0.5) can be achieved, which promotes rapid clamping and release.

According to an embodiment of the invention, a cylinder is provided as the actuator of the transverse slides, the slide block of the transverse slides being connected with the piston by a piston rod. The required movements during clamping and release can thereby be implemented in a simple manner.

According to an advantageous suggestion of the invention, a position-indicating bolt that shows the engaged and disengaged position of the coupling pinion extends axially in the chuck head plate, is displaced synchronously with the coupling pinion as a function of its movement, and has a front end that can be seen from the outside on the head plate. The machine operator therefore always has precise knowledge about the functional position of the coupling pinion and can engage or disengage the coupling pinion accordingly, depending on the machining requirement (centered with direct alignment relative to the machine center, or noncentric clamping).

Further characteristics and details of the invention are evident from the claims and from the following description of an exemplary embodiment of the invention shown in the drawings. These show:

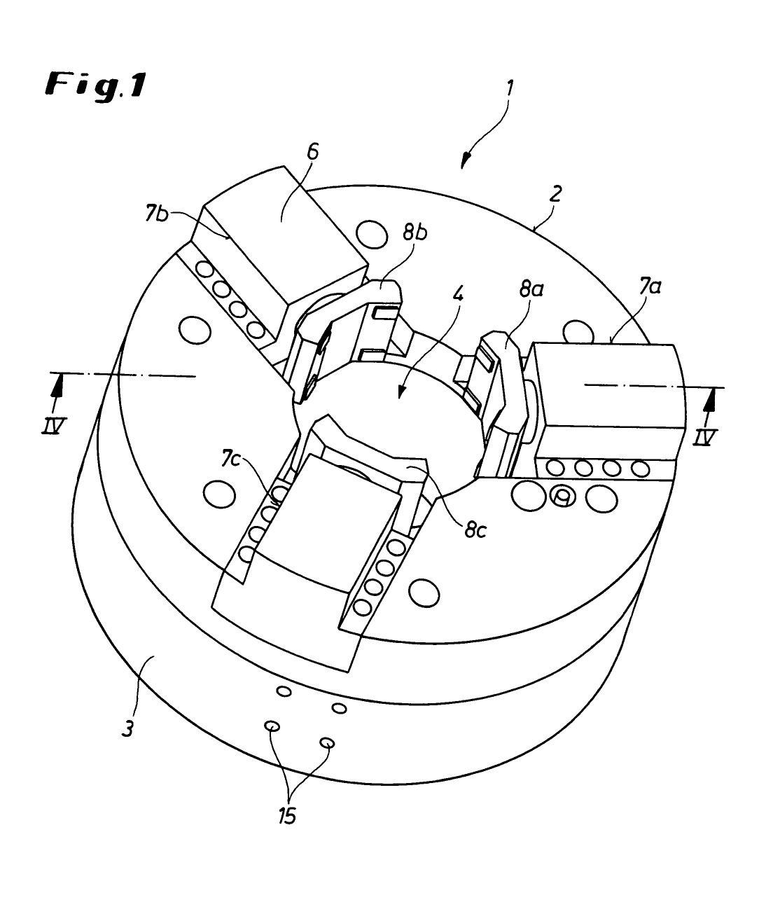

FIG. 1 is a perspective front view of a detail of a chuck of a machining apparatus;

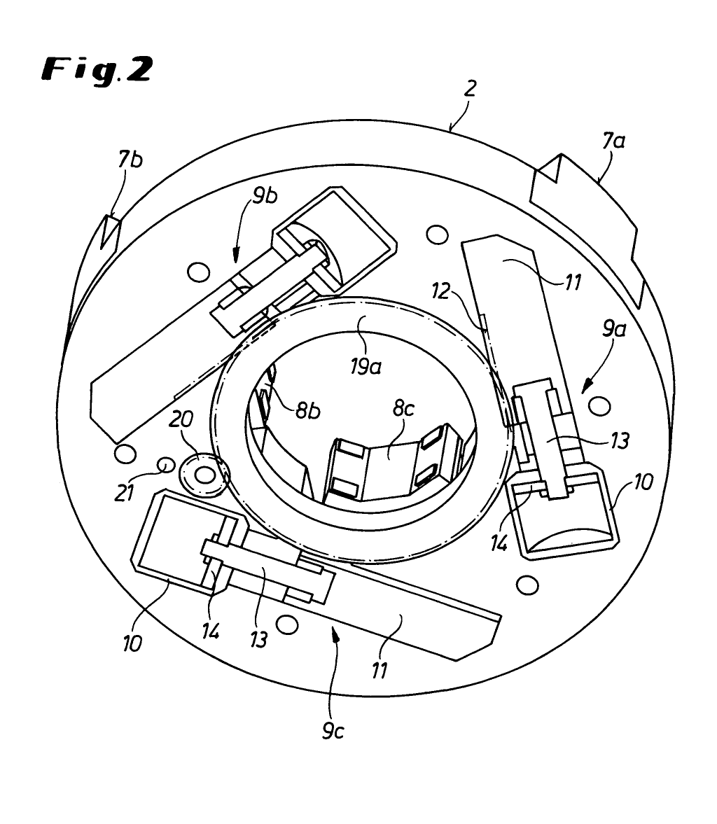

FIG. 2 is a perspective sectional view of the chuck of FIG. 1;

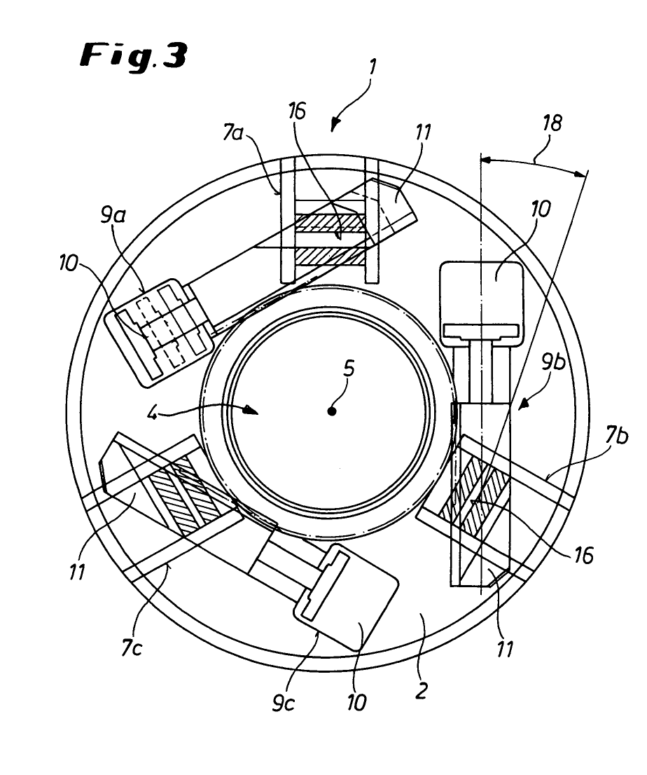

FIG. 3 is a view like FIG. 1 FIG. 2 but from the rear of the chuck with the transverse slide oriented relative to the chuck slides in a position at a slant, in an engagement angle;

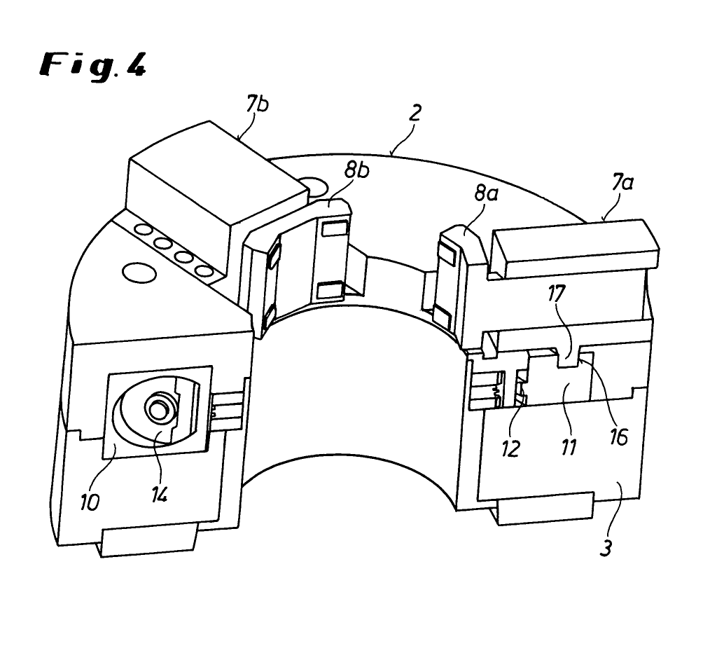

FIG. 4 an axial section through the chuck of FIG. 1 approximately along the line IV-IV; and

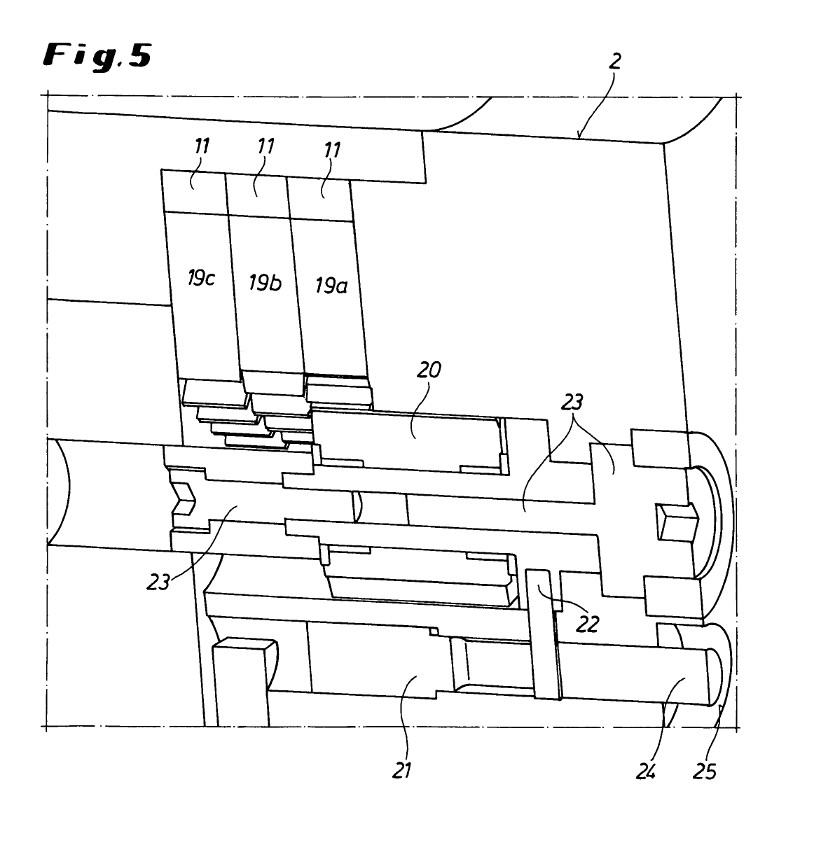

FIG. 5 is an axial section through a detail of the chuck at a coupling pinion that can be engaged into and disengaged from three gears connected separately with the chuck slides.

A chuck 1 of an apparatus for cutting threads or threaded connectors on pipe ends, shown in FIG. 1, consists of a head plate 2 and a housing ring [3] behind it. To accommodate an unillustrated pipe to be threaded, the chuck 1 has a central throughgoing passage 4 whose center 5 coincides with the axis of the pipe rotating with the chuck. The front face of the head plate 2 carries three equiangularly spaced chuck slides 7a, 7b, and 7c with respective jaws 8a, 8b, and 8c that have covers 6 and can be positioned radially relative to the center rotation axis 5 to grip the pipe centered on the axis 5 (see FIG. 3).

To move the chuck slides 7a, 7b, and 7c with the jaws 8a, 8b, and 8c radially of the center rotation axis 5 of the chuck 1, each chuck slide 7a, 7b, and 7c, has a respective transverse slide 9a, 9b, and 9c recessed in the head plate 2 it and movable tangentially to the rotation axis 5. These slides each consist, as can be seen in FIG. 2, of a hydraulic cylinder 10 as an actuator and a slide block 11 that is formed as a rack 12 on a longitudinal side and that is connected with a piston 14 by a piston rod 13. To move the pistons 14, the hydraulic cylinders 10 are connected with an unillustrated fluid-pressure supply by of connectors 15 (see FIG. 1).

At their fronts, which lie at the back in the drawing plane in FIG. 2, the slide blocks 11 are each formed with a guide groove 16 extending an acute angle and in which a follower claw 17 on the underside of the chuck slides 7a, 7b, and 7c engages at an engagement angle 18 (see FIG. 3) of preferably 30°. When the hydraulic cylinders 10 are pressurized, the follower claw 17 is displaced along the angled guide groove 16 like by a cam and the jaws 8a, 8b, and 8c are moved radially inwardly toward the axis 5 on the respective chuck slides 7a, 7b, and 7c of the chuck. The angular extension with the engagement angle 18 allows fast, short-stroke positioning of the jaws 8a, 8b, and 8c, for example with a stroke of the transverse slides 9a, 9b, and 9c of 50 mm produced by a stroke of 25 mm.

Each transverse slide 9a, 9b, and 9c has a respective gear 19a, 19b, and 19c in the chuck 1 axially stacked along the central throughgoing passage 4, from the front to the rear (see FIG. 5), of which only the frontmost gear 19a can be seen in FIG. 2. The hydraulic cylinders 10 are operatively coupled with the respective gears 19a, 19b, or 19c by the racks 12 of the respective slide blocks 11. The gears 19a, 19b, and 19c have a coupling pinion 20 that can be engaged and disengaged axially relative to their rotation axis 5 (see FIGS. 2 and 5) and that meshes with all the gears 19a, 19b, and 19c in the engaged position for synchronous movement of the three gears 19a, 19b, and 19c and thereby of the chuck slides 7a, 7b, and 7c in order to clamp a pipe on center.

If, on the other hand eccentric clamping is to take place, the coupling pinion 20 is disengaged and is then in engagement only with one gear, the outermost gear 19a. Thus, all three slide systems, with the respective connected gears can move independently, adapt to the pipe at different spacings from the center, and clamp it in place.

As can be seen in FIG. 5, which shows a partial detail of the chuck, a position-indicating bolt 21 is provided extending axially parallel to and coupled to the pinion 20 and displaced synchronously therewith, here connected with the coupling pinion 20 by a rod or crosspiece 22. With the possibility of manual engagement and disengagement of the coupling pinion 20 that exists in this embodiment, for which purpose threaded bolts 23 are used, the position-indicating bolt 21 is displaced axially forward and rearward, thereby causing a front end section 24 that shows the respective position move into a recess (bore) 25 of the chuck head plate 2 either to a greater (the coupling pinion 20 engaged into all the gears 19a, 19b, and 19c) or lesser extent (the coupling pinion 20 meshes only with the front gear 19a).

The chuck 1 described is suitable both as a tailstock chuck and, in particular, as a headstock chuck, and fulfills the required chucking function of clamping with direct alignment relative to the machine center, in centered manner, and/or of eccentric clamping of the pipes to be machined.

Reference Symbol List:

| | |
|---|---|
| 1 | chuck |
| 2 | head plate |
| 3 | housing ring |
| 4 | throughgoing passage |
| 5 | center (of the |
| | chuck)/rotation axis of a |
| | clamped pipe |
| 6 | cover/housing |
| 7a, b, c | chuck slide |
| 8a, b, c | jaw |
| 9a, b, c | transverse slide |
| 10 | hydraulic cylinder |
| 11 | slide block |
| 12 | rack |
| 13 | piston rod |
| 14 | piston |
| 15 | pressure medium connector |
| 16 | guide groove in the manner |
| | of a motion link |
| 17 | follower claw |
| 18 | engagement angle |
| 19a, 19b, and 19c | gear |
| 20 | coupling pinion |
| 21 | position-indicating bolt |
| 22 | crosspiece/rod |
| 23 | screw thread bolt |
| 24 | end section (of the |
| | position-indicating bolt) |
| 25 | recess (bore in the head |
| | plate) |

1. A chuck for an apparatus for machining a tubular workpiece rotating about a rotation axis that coincides with the center of the chuck, comprising at least two chuck slides that are movable radially relative to the rotation axis, for freeing and gripping the workpiece, are mounted on the face side of a chuck head plate, equiangularly angularly spaced on it, and carry respective jaws, wherein transverse slides movable in the head plate tangentially relative to the rotation axis and each acted on by a respective actuator each have a slide block formed on one longitudinal side as a rack meshing with a respective gear of each chuck slide, each chuck slide being provided on a respective back face with a follower claw engaging in a respective guide groove formed in the slide block of the respective transverse slide to convert its movement into a positioning movement of the respective chuck slide that moves radially of the rotation axis the gears having a coupling pinion that can be engaged and disengaged axially relative to the rotation axis.

2. The chuck according to claim 1, wherein the transverse slides and the chuck slides are relatively movable at paths crossing at an acute engagement angle of the travel of follower claw and guide groove such that the stroke of the transverse slide into a shorter stroke of the chuck slide.

3. The chuck according to claim 1, wherein the coupling pinion that can be engaged and disengaged meshes with all three gears in the engaged end position, and with only one gear in the disengaged end position.

4. The chuck according to claim 1, further comprising:
cylinders as actuators of the transverse slides and having slide blocks are coupled with the respective pistons by respective piston rods.

5. The chuck according to claim 1, further comprising:
a position-indicating bolt that shows engaged and disengaged positions of the coupling pinion is mounted in the chuck head plate, extends axially parallel to the coupling pinion, moves synchronously with the coupling pinion, and has a front end section in the head plate that can be seen from outside.

6. A chuck for holding a tubular rotating workpiece in a machining apparatus, the chuck comprising:
a chuck body rotatable about an axis and having an axially front face;
a plurality of chuck slides angularly equispaced about the axis and movable radially of the axis on the front face and each carrying a respective tool-gripping jaw;
respective transverse slides movable tangentially of the axis rearward of the chuck slides and each having a radially to inwardly directed edge formed as a rack;
a respective rotary gear rotatable about the axis and threaded with each of the racks;
a respective axially forwardly directed formation on each of the transverse slides;
a respective axially rearwardly directed formation on each of the chuck slides fitting with the respective axially forwardly directed formation;
a coupling gear movable between an engaged position fitting with all of the rotary gears and coupling same together for joint rotation about the axis and a disengaged position permitting relative rotation of the rotary gears; and
respective actuators in the body connected to each of the transverse slides for tangentially moving same and thereby radially moving the respective chuck slides, whereby in the engaged position the jaws on the chuck slides will move radially synchronously for centered chucking of a workpiece and in the disengaged position the jaws can move radially independently for centering a nonround workpiece.

7. The chuck defined in claim 6, wherein the rotary gears are ring gears having external teeth meshing with the racks of the respective transverse slides and internal teeth meshable with the coupling gear.

8. The chuck defined in claim 6, wherein a travel path of each of the transverse slides forms an acute angle with a path of travel of the respective chuck jaw.

9. The chuck defined in claim 8, wherein the angle is less then 45°.

10. The chuck defined in claim 9, wherein the angle is 30°.
